(19) United States
(12) Patent Application Publication
(10) Pub. No.: US 2008/0230333 A1
(43) Pub. Date: Sep. 25, 2008

(54) Bicycle braking sheet assembly

(76) Inventor: Chester Wen, Taichung City (TW)

Correspondence Address: CHESTER WEN, 235 Chung - Ho, Box 8-24, Taipei, TW

(21) Appl. No.: 11/725,649

(22) Filed: Mar. 21, 2007

(51) Int. Cl. F16D 69/00

(52) U.S. Cl. 188/250 R

(57) ABSTRACT

A bicycle braking sheet assembly comprises a braking sheet being made of elastic material; the braking sheet being formed with a plurality of receiving holes; a plurality of braking blocks; the number of the braking blocks being equal to that of the receiving holes; the elastic coefficient of the braking blocks being different from that of the braking sheet; an outer shape of each braking block being corresponding to an inner shape of the receiving hole so that the braking block is exactly received in the receiving hole. An inner side of the braking sheet has a dirt remover. A projection extends from the dirt remover. An inner surface of the braking sheet is formed with a plurality of recesses and a plurality of first textures for increasing friction force. An inner surface of each braking block has a second texture.

### FIELD OF THE INVENTION

The present invention relates to brakes, and particularly to a bicycle braking sheet assembly which has a preferred effect in braking and the elastic coefficient of the braking blocks is different from that of the braking sheet so that the user can select desired friction effect.

### BACKGROUND OF THE INVENTION

In the prior art, bicycle brake has a braking unit with braking blocks. The brake unit is in contact with the wheel rim so as to apply force to the wheel rim to achieve the object of braking a wheel rim.

For some kinds of wheel rims with larger area, the contact area between the brake unit and the braking blocks is not sufficient so as to induce some dangerous conditions in driving. Moreover, the time period for braking is long and thus the lifetime of the brake is shortened.

In one prior art brake, the braking block has a T shape which is enclosed by a wear-tolerant rubber which has different color and material from the inner rubber. A surface of the outer rubber is formed with a plurality of -recesses for draining water. The surface is formed with inclined contact surface so that the braking block has steady braking effect. As the inner rubber exposes out and emits sound in braking, it is known that the braking block is necessary to be updated so as to achieve the object of safety.

However the prior art dose not increase the function of braking. The prior art brake unit has unique friction coefficient so that the friction effect is finite.

### SUMMARY OF THE INVENTION

Accordingly, the primary object of the present invention is to provide a bicycle braking sheet assembly which has a preferred effect in braking and the coefficient of the braking blocks is different from that of the braking sheet so that the user can select desired friction effect.

To achieve above objects, the present invention provides a bicycle braking sheet assembly which comprises a braking sheet being made of elastic material; the braking sheet being formed with a plurality of receiving holes; a plurality of braking blocks; the number of the braking blocks being equal to that of the receiving holes; the elastic coefficient of the braking blocks being different from that of the braking sheet; an outer shape of each braking block being corresponding to an inner shape of the receiving hole so that the braking block is exactly received in the receiving hole. In assembly, the braking blocks are received into the receiving holes from the outer side of the braking sheet. An inner side of the braking sheet has a dirt remover; when the braking sheet resists against a wheel rim, the dirt remover serves to remove dirt on the rim. A projection extends from the dirt remover for measuring a margin in installation so that the bicycle braking sheet assembly can be installed correctly. An inner surface of the braking sheet is formed with a plurality of recesses and a plurality of first textures for increasing friction force. An inner surface of each braking block has a second texture. An inner surface of each braking block has a second texture.

The various objects and advantages of the present invention will be more readily understood from the following detailed description when read in conjunction with the appended drawing.

### BRIEF DESCRIPTION OF THE DRAWINGS

FIG. 1 is an explosive schematic view of the bicycle braking sheet assembly of the present invention.

FIG. 2 is a schematic view showing an end surface of the bicycle braking sheet assembly of the present invention.

FIG. 3 is a schematic cross sectional view along line AB of FIG. 2.

FIGS. 4 and 5 are schematic views showing the applications of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

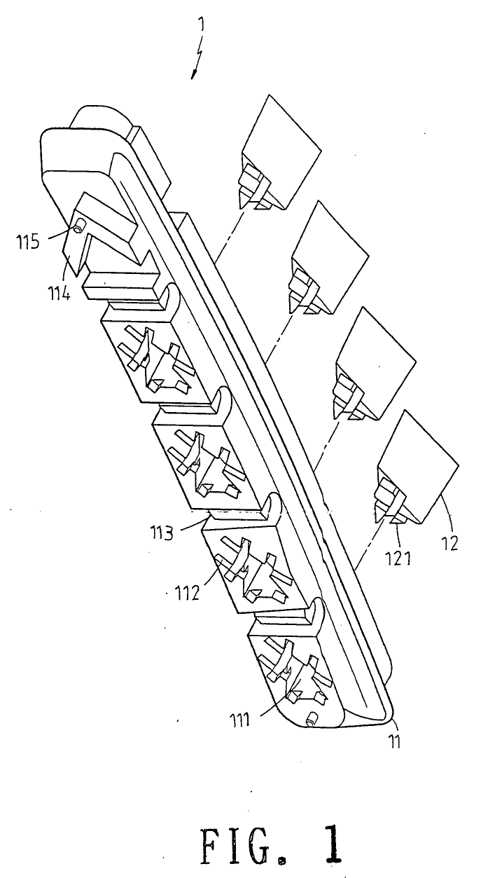

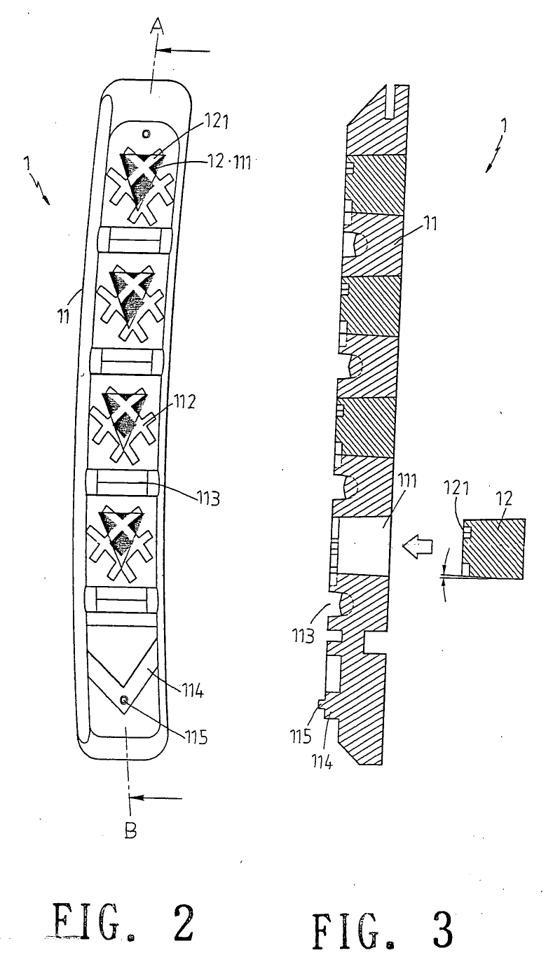

Referring to FIG. 1, the bicycle braking sheet assembly 1 of the present invention is illustrated. The present invention has the following elements.

A braking sheet 11 is made of elastic material. The braking sheet 11 is formed with a plurality of receiving holes 111. One outer side of the receiving hole 111 has a larger size than that of the inner side. The inner side of the braking sheet 111 has a dirt remover 114. When the braking sheet 11 resists against a wheel rim 3. The dirt remover 114 serves to remove dirt on the rim 3. A projection 115 extends from the dirt remover 114 for measuring a contact margin in installation so that the bicycle braking sheet assembly can be installed correctly. An inner surface of the braking sheet 11 is formed with a plurality of recesses 13 and a plurality of first textures 112 for increasing friction force. The recesses 13 serve for assuring the friction of the braking sheet 11 for determining whether it is necessary to update the bicycle braking sheet assembly.

A plurality of braking blocks 12 are the included. Each braking block 12 has a wedge shape. The number of the braking blocks 12 is equal to that of the receiving holes 111. The elastic coefficient of the braking blocks 12 is different from that of the braking sheet 11. An outer shape of each braking block 12 is corresponding to an inner shape of the receiving hole 111 so that the braking block 12 is exactly received in the receiving hole 111. An inner surface of each braking block 12 has a second texture 121. In assembly, the braking block 12 is received in a corresponding receiving hole 111 so that at the inner side of the braking sheet 11, the first texture 112 and second texture 121 are formed as a shape of [symbol] (a Chinese character with a pronunciation of “chin”) so as to increase the friction force of the bicycle braking sheet assembly of the present invention.

In assembly, the braking blocks 12 are received into the receiving holes 111 from the outer side of the braking sheet 11. Because the elastic coefficient of the braking sheet 11 is different from that of the braking block 12, they have different friction effects. The user can select the materials of the braking block 12 and braking sheet 11 as desired so as to have desire effect. When the braking sheet 11 is in contact with the wheel rim 3, the dirt remover 114 has the effect of removing the dirt on the rim 3. Thus the braking sheet 11 will not slide along the wheel rim 3.

In assembly, the braking block 12 is received in a corresponding receiving hole 111 so that at the inner side of the braking sheet 11, the first texture 112 and second texture 121 are formed as a shape of [symbol] so as to increase the friction force of the bicycle braking sheet assembly of the present invention.

The projection 115 extended from the dirt remover 114 serves for measuring a margin in installation so that the bicycle braking sheet assembly can be installed correctly. The user can adjust the distance between the braking sheet 11 and the wheel rim 3 without needing to drive the braking handle.

Moreover, the recesses 13 in the inner side of the braking sheet 11 have the effect of determining the wearing effect of the braking sheet 11. When the recesses 13 are worn and for a long time the recess 13 is near a flat surface. The bicycle braking sheet assembly is necessary to be updated.

Thus from above assembly, the user can select braking blocks 12 with desired elastic coefficient so as to adjust the necessary braking effect.

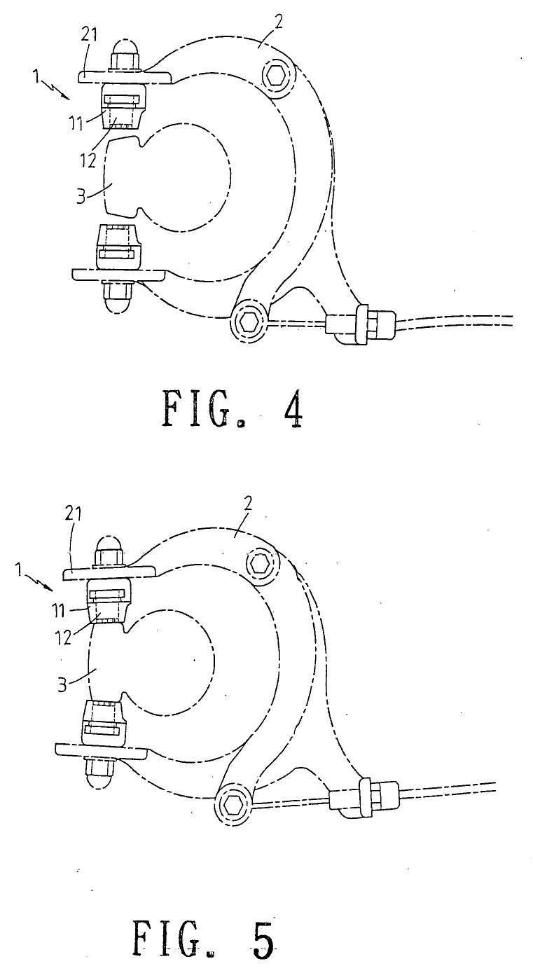

Referring to FIGS. 4 and 5, in assembly, the outer side of the braking sheet 11 is combined to the hoof sheet 21 of a brake 2. When the user drives the brake handle (not shown). The brake 2 is actuated and the brake 2 will drive the hoof sheet 21 to move near the wheel rim 3 so that the braking sheet 11 is adhered to the wheel rim 3. By the deformations of the braking sheet 11 and braking blocks 12, and increment the friction force between the braking sheet 11 and the wheel rim 3 through functions of the first texture 112, second texture 121 and recesses 13, the wheel rim 3 will be stopped. The selection of the elastic coefficients of the braking blocks 12 and braking sheet 11 will have different friction effect.

In the present invention, a material of the braking block includes metal powders so as to increase a strength and tolerance of the material.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle braking sheet assembly comprising:
a braking sheet being made of elastic material; the braking sheet being formed with a plurality of receiving holes;
a plurality of braking blocks; the number of the braking blocks being equal to that of the receiving holes; the elastic coefficient of the braking blocks being different from that of the braking sheet; an outer shape of each braking block being corresponding to an inner shape of the receiving hole so that the braking block is exactly received in the receiving hole;
wherein in assembly, the braking blocks are received into the receiving holes from the outer side of the braking sheet.

2. The bicycle braking sheet assembly as claimed in claim 1, wherein an inner side of the braking sheet has a dirt remover; when the braking sheet resists against a wheel rim, the dirt remover serves to remove dirt on the rim.

3. The bicycle braking sheet assembly as claimed in claim 1, wherein a projection extends from the dirt remover for measuring a contact margin in installation so that the bicycle braking sheet assembly can be installed correctly.

4. The bicycle braking sheet assembly as claimed in claim 1, wherein an inner surface of the braking sheet is formed with a plurality of recesses.

5. The bicycle braking sheet assembly as claimed in claim 1, wherein an inner surface of the braking sheet is formed with a plurality of first textures for increasing friction force.

6. The bicycle braking sheet assembly as claimed in claim 1, wherein an inner surface of each braking block has a second texture.

7. The bicycle braking sheet assembly as claimed in claim 5, wherein an inner surface of each braking block has a second texture, in assembly, the braking block is received in a corresponding receiving hole so that at the inner side of the braking sheet, the first texture and second texture are formed as a shape of

[symbol]

8. The bicycle braking sheet assembly as claimed in claim 1, wherein each braking block has a wedge shape.

9. The bicycle braking sheet assembly as claimed in claim 1, wherein one outer side of the receiving hole has a larger size than that of the inner side.

10. The bicycle braking sheet assembly as claimed in claim 1, wherein a material of the braking block includes metal powders so as to increase a strength and tolerance of the material.
